(19) United States
(12) Patent Application Publication
(10) Pub. No.: US 2008/0137831 A1
(43) Pub. Date: Jun. 12, 2008

(54) Podcast Of Conference Calls

(76) Inventor: Jonathan Khorsandi, Solana Beach, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/932,818

(22) Filed: Oct. 31, 2007

Related U.S. Application Data
(60) Provisional application No. 60/863,678, filed on Oct. 31, 2006.

(51) Int. Cl. H04M 3/42

(52) U.S. Cl. 379/202.01

(57) ABSTRACT

A system and method for generating, storing and distributing teleconference audio content is disclosed. A bridge line is established for a teleconference among a number of participants and at least one moderator. Each of the participants and the at least one moderator uses a telephone device to communicate with the bridge line. The teleconference is recorded as digital storage format information. The digital storage format information associated with the teleconference is then converted into digital playback format information. The digital playback format information is distributed as a podcast to a number of designated recipients

### CROSS REFERENCE TO RELATED APPLICATION

The present patent application claims priority under 35 U.S.C. §119 to U.S. Provisional Patent Application Ser. No. 60/863,678 filed on Oct. 31, 2006, and entitled, “Podcast of Conference Calls” the entire disclosure of which is incorporated by reference herein.

### BACKGROUND

This disclosure relates generally to conference-oriented podcasting, and more specifically it relates to a podcast of conference calls, or teleconferences, such that an organization can easily conduct conference calls for training and educational purpose and have the recorded conference call get pushed out to subscribers via podcast.

It can be appreciated that audio conferencing has been in use for years. Typically, audio conferencing is comprised of conference calling companies that offer toll numbers for people to dial into and host a call with numerous simultaneous callers. Some offer recording services of such calls and few offer other services such as transcripting calls. A handful of service providers offer some sort of podcasting service.

The main problem with conventional audio conferencing is that they are cumbersome and offer only partial solutions to a pain that users endure because they can't imagine a better way. Some conference calling companies charges upwards of $35 to record the call and users (hosts) have to pull the audio from an ftp site and then archive the call and upload to a website that callers can visit to re-listen to the audio. Another problem with conventional audio conferencing is the inconvenience for call participants to review the calls. They either have to log onto a website and sit at the computer to listen or dial into the original bridge line and listen through their phone. If a host has multiple classes he/she will have to host multiple sites for audio review and multiple access codes for participants. Another problem with conventional audio conferencing is the lack of an organized archive for the host or the participant other than what they make up on the fly.

While these devices may be suitable for the particular purpose to which they address, they are not as suitable for any organization to easily conduct conference calls for training and educational purpose and have the recorded conference call get pushed out to subscribers via podcast. The main problem with conventional audio conferencing is that they are cumbersome and offer only partial solutions to a pain that users endure because they can't imagine a better way. Some conference calling companies charges upwards of $35 to record the call and users (hosts) have to pull the audio from an ftp site and then archive the call and upload to a website that callers can visit to re-listen to the audio. Another problem is that it is inconvenient for call participants to review the calls. They either have to log onto a website and sit at the computer to listen or dial into the original bridge line and listen through their phone. If a host has multiple classes he/she will have to host multiple sites for audio review and multiple access codes for participants. Also, another problem is There is no organized archive for the host or the participant other than what they make up on the fly.

In these respects, the podcast of conference calls according to the present invention substantially departs from the conventional concepts and designs of the prior art, and in so doing provides an apparatus primarily developed for the purpose of any organization to easily conduct conference calls for training and educational purpose and have the recorded conference call get pushed out to subscribers via podcast.

### SUMMARY

In view of the foregoing disadvantages inherent in the known types of audio conferencing now present in the prior art, a number of systems and methods provide a podcast of conference calls construction wherein the same can be utilized for any organization to easily conduct conference calls for training and educational purpose and have the recorded conference call get pushed out to subscribers via podcast.

The general purpose of the described systems and methods, which will be described subsequently in greater detail, is to provide a way to podcast conference calls that has many of the advantages of the audio conferencing mentioned heretofore and many novel features that result in a way to podcast conference calls which is not anticipated, rendered obvious, suggested, or even implied by any of the prior art audio conferencing, either alone or in any combination thereof.

To attain this, a system and method generally comprises an audio conferencing bridge line, custom software that allows for instant transfer of audio, custom software that assigns audio to user determined and user created Real Simple Syndicate (RSS) feeds that push that very audio and video to the end listener based on permissions and usability. Another component is the ability to create unlimited amounts of feeds and podcast series using just one phone number, assuming only one call can take place at the time. The system utilizes an audio conferencing bridge line that can host up 10,000 participant callers and 500 moderator callers at the same time.

A web console and phone commands allow for functions such as muting, recording and grouping of call participants custom web service and software that fetches recorded audio from telecom server and drops that file into the podference server to the right client. adds gain, converts from .wav format to .mp3 format and assigns attributes based on user pre-determined details. final component makes sure audio gets assigned to correct client, series and episode. once archived, the RSS feed instantly signals to podcatchers in on the web that new audio is available and subscribers will get that latest audio automatically downloaded into their podcatcher like iTunes and synch to their portable player, such as an iPod or other digital content player device, if they have one.

In one aspect, a method includes establishing a bridge line for a teleconference among a number of participants and at least one moderator. Each of the participants and the at least one moderator use a telephone device to communicate with the bridge line. The method further includes recording the teleconference as digital storage format information, and converting the digital storage format information associated with the teleconference into digital playback format information. The method further includes distributing the digital playback format information as a podcast to a plurality of recipients.

In another aspect, a method includes a computer-implemented method for distributing teleconference audio content. The method includes storing audio content from a bridge line associated with a teleconference, converting the stored audio content to a podcasting format associated with a podcasting website, and distributing the stored audio content in the podcasting format to one or more recipients having access to the podcasting website.

In yet another aspect, a system for distributing teleconference audio content includes a setup page for receiving user information associated with one or more stored audio files. The system further includes a server system for storing the received user information with the one or more stored audio files, and for accessing the stored audio files upon receipt of a query associated with the user information. The system further includes a podcasting server coupled with the server system for distributing the accessed audio files to one or more recipients associated with the query.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a system for creating a podcast from a conference call.

FIG. 2 is a phone interface showing a recording of a teleconference that has been initiated by a moderator.

FIG. 3 illustrates an exemplary web console that includes one or more web pages that provide a control interface.

FIG. 4 illustrates an exemplary podcast setup page.

FIG. 5 illustrates a synchronizing function from the podcast setup page.

FIG. 6 shows a user setup page in which a user can enter user information.

FIG. 7 shows an account settings page or window in the user information can be displayed, and account settings can be configured.

FIGS. 8-11 are flowcharts of various methods for podcasting recorded teleconferences.

Like reference symbols in the various drawings indicate like elements.

### DETAILED DESCRIPTION

This document describes systems and methods for providing a podcast of conference calls for any organization to easily conduct and record conference calls for training and educational purpose, and have the recorded conference call get “pushed out” or broadcast to subscribers via podcast. This description refers to conference calls and teleconferences interchangeably. The podcasts can also be pushed out to call participants for their review and/or to the public for marketing and/or exposure purposes. The system and methods offer a fully streamlined solution, from setting up the calls with descriptions and title, to hosting and recording the call and immediately associating the correct attributes (title, description, etc.) to the recorded audio content of the call, and then finally creating the podcast feed and podcasting the audio out subscribers or other participants.

In one implementation, a system offers a dedicated bridge line that the host owns and to which no one else has access. The private feeds and bridge lines can be secure. For example, a special personal identification number (PIN) code can be assigned to each participant caller and moderator so that the host/moderator can see who is on the call. The private feeds allows for the moderator/host to shut down an individual feed should that individual no longer be allowed to listen to audio and/or access the live calls.

In some implementations, a system and method provide a web-based console that monitors the call in real-time, to be able to view how many participants are on the call and their identifiers such as names, and have ability to mute individual callers and/or drop them from the call at will. Moderators can use the web-based console to break the conference call into sub-groups. For example, if a call has 200 participants, the moderator could break the group into ten sub-groups of 20 participants each. The moderator can, in turn, patch themselves into each sub-group and speak to those participants in that group without interfering with other groups. The moderator can also then select any individual of the 200 participants and start a private conversation. The system and method provide an option to list a public call and feed in the public podcasting directories and a podcast site such as iTunes.

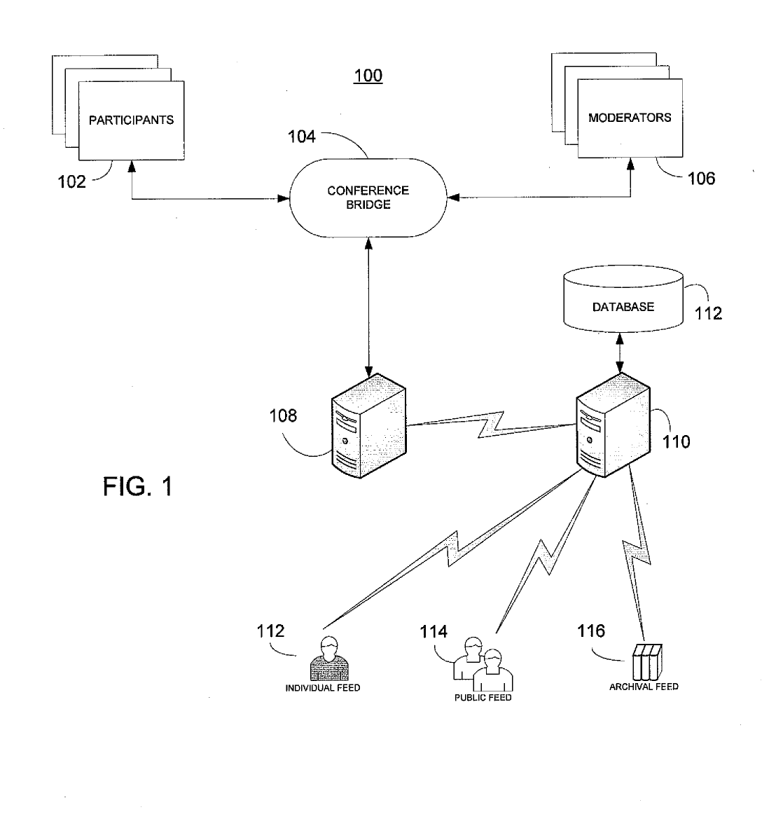

FIG. 1 is a block diagram of a system for creating a podcast from a conference call 100. The conference call includes a number of participants 102 that can be concurrently participating in the conference call, in communication with each other via conference bridge 104. In some implementations, there can be up to 10,000 or more concurrent participants 102 on the same conference call. All participants 102 share the same access code. The conference call 100 can also include a number of moderators 106 that moderate the participants 102 and/or content of the conference call 100. In some implementations, there can be up to 500 moderators 106 on the same conference call 100. Each moderator can have the same access code to access the conference call 100, but which is preferably different than the access code of each participant 102.

The system includes a telecom server 108 that records and stores the teleconference from the conference bridge. The teleconference can be stored in any digital media audio format, such as .WAV, or other computer-readable format. The telecom server 108 is connected to a podcast server 110 via one or more communication networks, which can include one or more wireless data networks. The podcast server 110 fetches an audio file of one or more teleconferences, or parts thereof, from the telecom server 108 and stores it in a database 112. The database 112 can be part of the podcast server 110. The podcast server 110, either automatically or under control of user commands, adds gain (volume) and other digital enhancements, and converts the audio file to a format that can be used by one or more selected digital audio player devices or software products. For example, the podcast server 110 converts a WAV file to an MP3 file. The converted file is stored in the database 112 in a directory for immediate access and distribution.

Once recorded and converted, the audio file is stored according to client, client series, series episode, and/or outgoing podcast identifier. The client classification can be based on client name and/or moderator ID, either of which is determined during account setup. The series is based on the podcast series name and description, both of which are determined by a user. Finally, the episode is based on a description of the episode and is also set up by the user. Both the series and episode information is RSS ready when set up by the user. Accordingly, all information relating to the audio file to identify, classify, store and access the audio file can be stored in client account, and given ahead of when an actual audio file is recorded and stored, or even before a teleconference takes place.

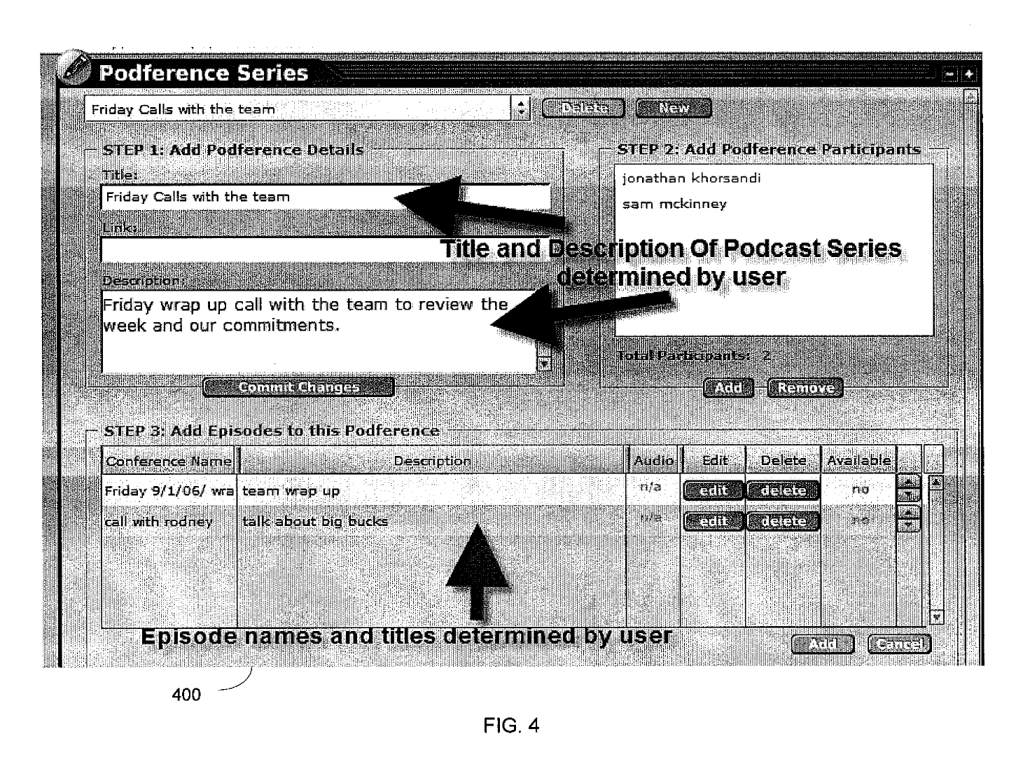

RSS feeds can be created in a podcast setup page (FIG. 4) that is stored and executed by the podcast server, to feed the podcast files to individual users 112, public groups 114, or archival storage 116. Individual user feeds are secure and private to call participants, and can be transmitted or otherwise accessed by the individual users 112 via personal identification number or other security identification, and can be tagged as premium content for being shared in a closed group. Public group feeds are submitted to public directories for immediate update and accessibility by any member of the public group 114. Security need not be as robust as with individual users 112. Archival storage feeds 116 can also be made available on a publicly-accessible or private podcasting site, such as iTunes or other online digital audio marketplace, which can be a subscription-based service or per-download based service.

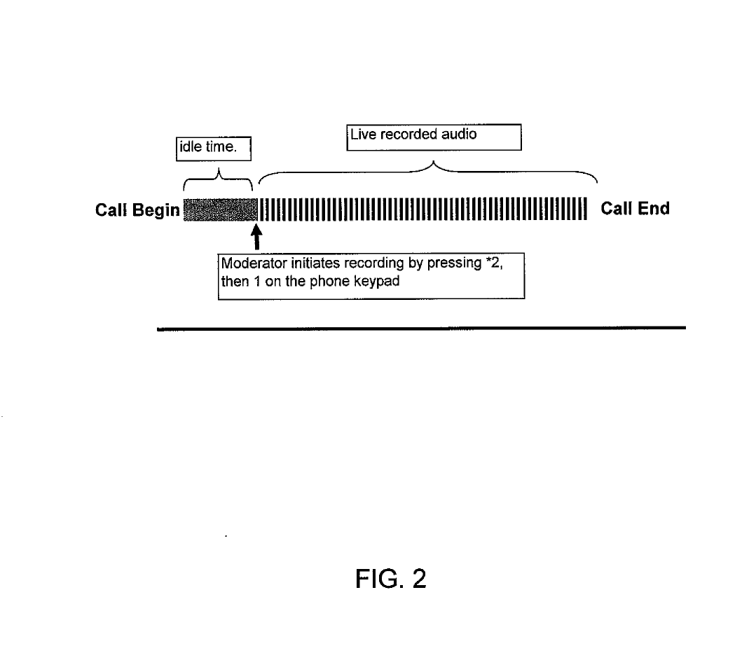

FIG. 2 is a phone interface 200 showing a recording of a teleconference that has been initiated by a moderator. The phone interface 200 can be generated by phone or by web console. The phone interface 200 provides a representation of a teleconference, including a call beginning, a call end, an indication of idle time, and an indication of live recorded audio (i.e. when one or more participants and/or moderators are speaking during the teleconference). A moderator initiates recording of the teleconference by pressing a predetermined button on a telephone interface, which can be a telephone keypad, a representation of a keypad, or other control interface.

Table 1 below illustrates a number of calling commands that can be implemented in a podference system in a preferred telephone interface.

Podference Calling Commands

PARTICIPANT FEATURE KEYS
*6 Mute/Un mute - caller controlled muting
*8 Count - plays the number of parties in the call
MODERATOR FEATURE KEYS
*2 Records the conference call.
*5 Mutes all participants
*6 Mute/Un mute - caller controlled muting
*7 Secured/Unsecured - stop callers from entering
*8 Count - plays the number of parties in the call

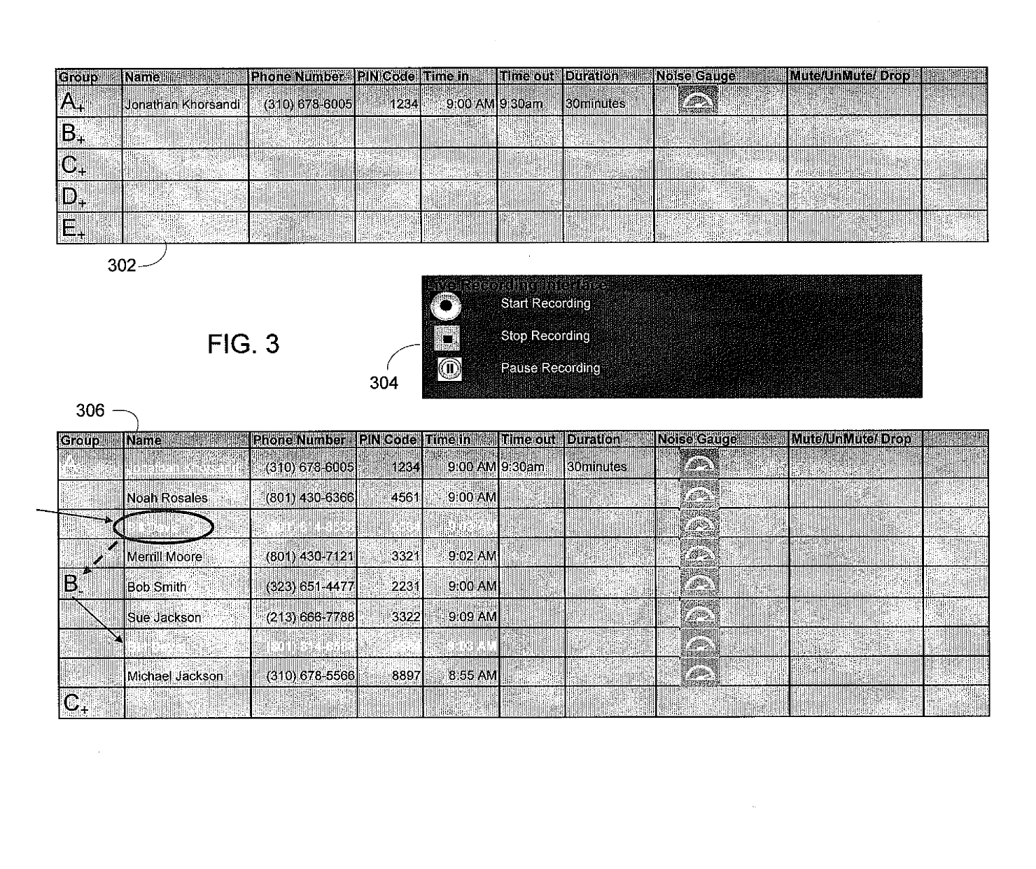

FIG. 3 illustrates an exemplary web console 300 that includes one or more web pages that provide a control interface. The web console 300 can include a main page 302 that lists a number of groups, and for each group one or more names, phone numbers, PIN codes, time in, time out, and duration of the teleconference. The main page 302 can also include, for each group, a graphical noise gauge that shows a noise level for each participant and/or moderator on the teleconference, as well as a mute/un-mute/drop control.

The main page 302 enables a moderator to expand any group that is represented by an expansion icon (i.e. a “+” symbol), mute one or more participants to the teleconference, add gain to the noise level of any participant, and subdivide a group into subgroups. A collapse icon (i.e. a “−” symbol) indicates that a group is displayed as expanded, and can be collapsed by clicking on it. A live recording interface 304 can be shown in the same or separate window or page, and includes a “start” control, a “stop” control, and a “pause” control for recording the teleconference.

Expanded view page 306 illustrates and expanded view of the main page 302, in which a moderator using the web console can click on a group or a person and have a private, separate conversation with that person or group. The conversation can include voice or data, such as text messaging. Further, the moderator using the web console can drag and drop one or more participants of one group into another group, as shown. Thus, the moderator can designate any participant of a group to be a participant of another group.

FIG. 4 illustrates an exemplary podcast setup page 400 of a podference system, in which a user can set up a podference series. The user can enter a title and a description of the series, which are associated with the audio file in the database to create the podference podcast. The podcast setup page 400 enables a user to add participants, make edits to a title and/or description of a series, or delete the series or any information related to the series. RSS feeds are created when users set up their series and schedule calls for each episode. Audio then gets dropped into the appropriate RSS feed. All users get an update with the latest audio via podcasting.

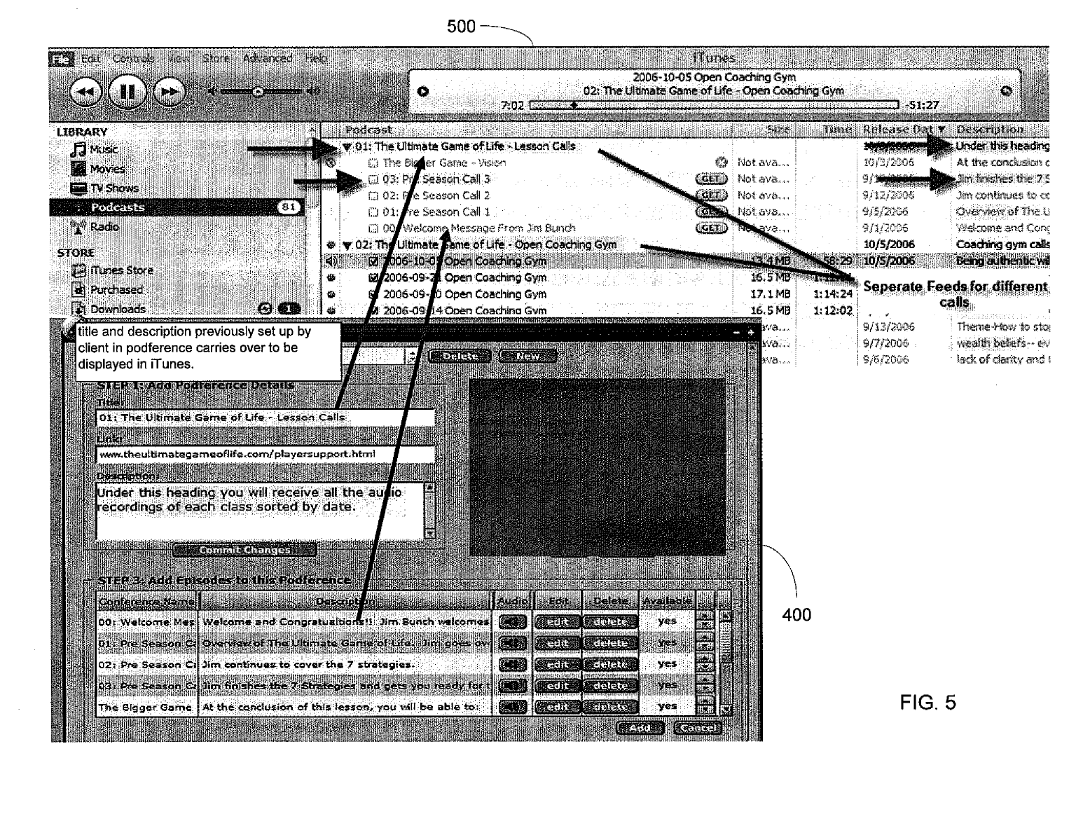

FIG. 5 illustrates a synchronizing function from the podcast setup page 400 to a podcatcher application 500 such as iTunes. If a digital audio player device, such as an iPod, is available, the audio will automatically synch to it. The title and description that were entered into the podcast setup page 400 automatically carry over to the podcatcher application 500 to be displayed there, as illustrated in FIG. 5.

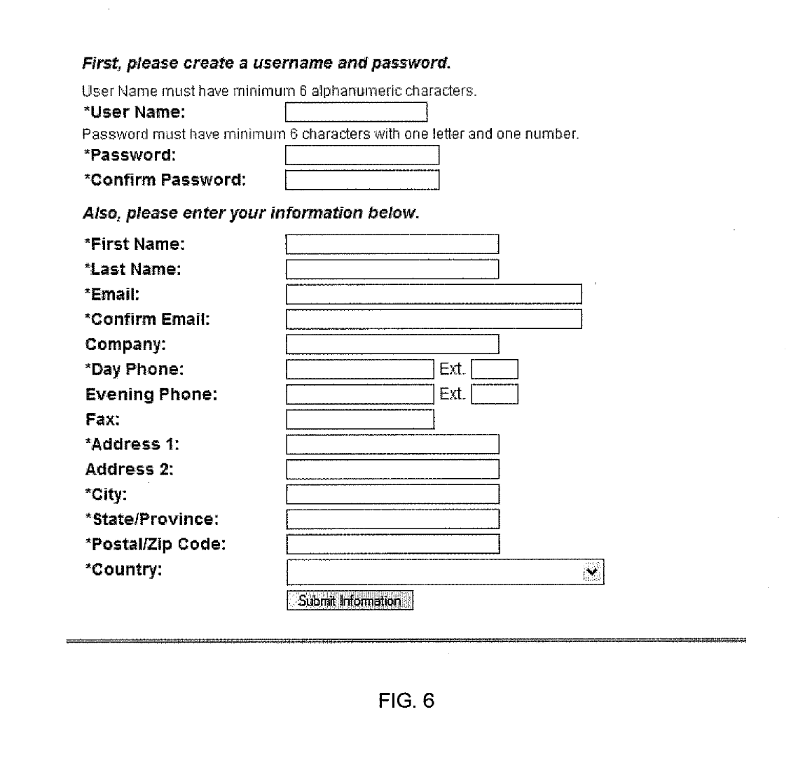

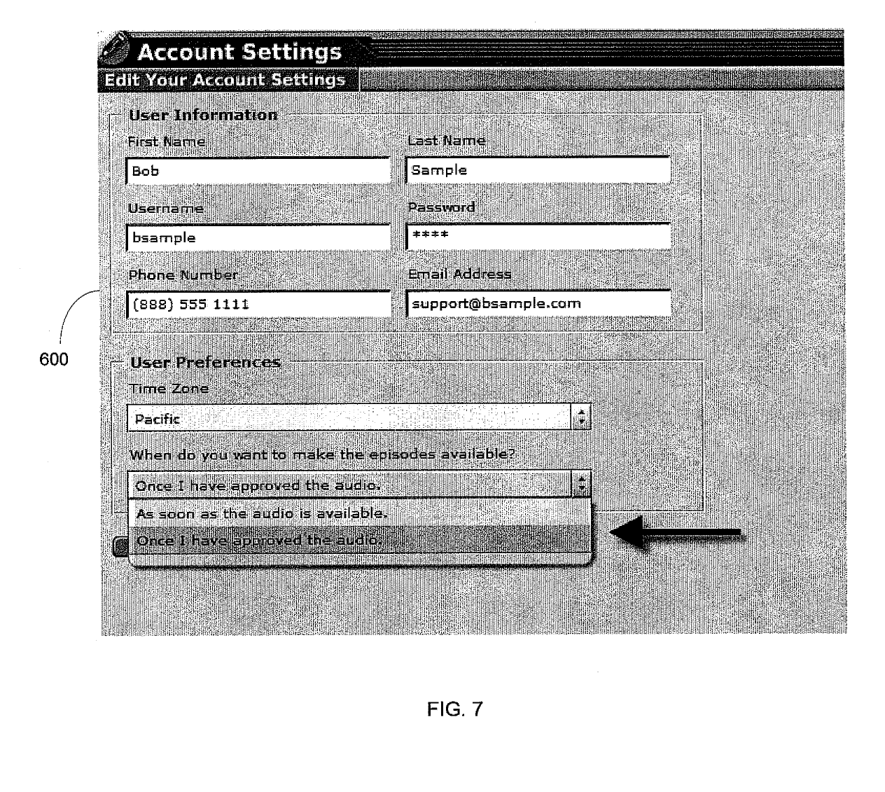

FIG. 6 shows a user setup page in which a user can enter user information. FIG. 7 shows an account settings page or window in the user information can be displayed, and account settings can be configured. For instance, a user can specify whether episodes of audio files can be made available to the user or other users as soon as possible, or once the user has approved of the audio.

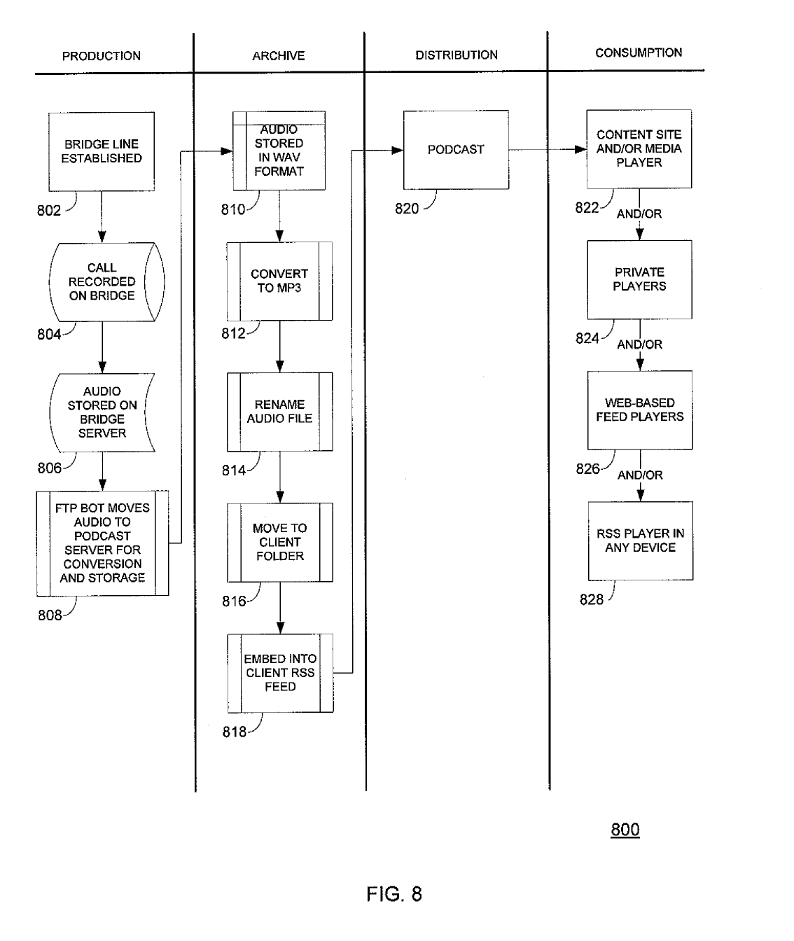

FIGS. 8-11 are flowcharts of various methods for podcasting recorded teleconferences. Each method include producing audio files, archiving the audio files, distributing the archived audio files, and consumption of the archived audio files by one or more various parties via a particular podcasting channel or player system.

With reference to FIG. 8, there is shown a flowchart of a podcasting method 800 for podcasting teleconference audio content. At 802 a teleconference bridge line is established. The bridge line is a dedicated telecommunications connection to which a number of participants and moderators can be connected. At 804, the teleconference (i.e. “the call”) is recorded from the bridge line, and stored on a bridge server or other telecommunications server at 806. At 808, a file transfer automated program, or “bot,” transfers or pulls the stored audio from the bridge server to a podcast server, where it is converted into a new digital audio format conducive to a digital audio player and for storage.

At 810, the digital audio is stored in its new format, and at 812 converted to a format that is ubiquitously and easily disseminated, such as MP3. At 814, the audio is renamed, and can be tagged with various other metadata that is associated with the stored audio, and which can be searched for in a query. At 816, the stored audio content is moved to a client folder. At 818, the audio is embedded into a client RSS feed for distribution to a number of recipients. At 820, the audio is distributed in a podcast, i.e. packaged and transmitted in a downloadable digital audio format that can be locally stored on a digital audio player device or similar player, and played-back at the convenience of the recipient.

At 822-828, the audio content is consumed. The podcast containing the audio content can be consumed at a content site and/or media player (822), one or more private digital audio players (824), one or more web-based feed players (826), and/or an RSS player in any device, such as computer, PDA, mobile phone, or other device.

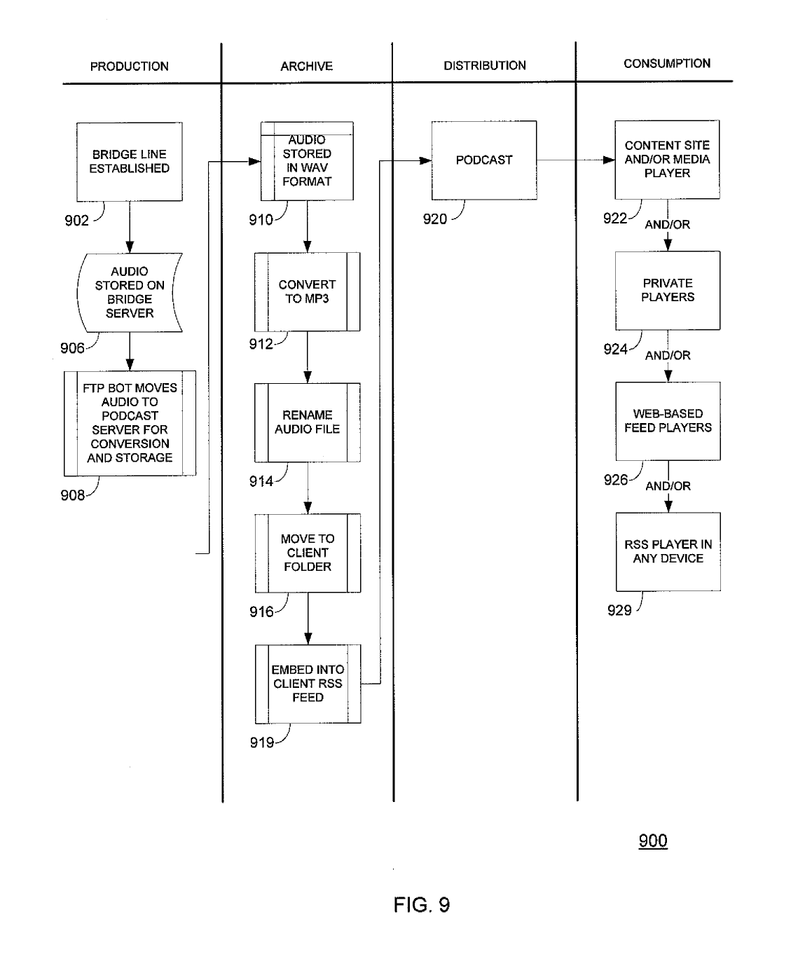

FIG. 9 is a flowchart of a podcasting method 900 for podcasting teleconference audio content. At 902 a teleconference bridge line is established, and the teleconference (i.e. “the call”) is stored on a bridge server or other telecommunications server at 906. At 908, a file transfer automated program, or “bot,” transfers or pulls the stored audio from the bridge server to a podcast server, where it is converted into a new digital audio format conducive to a digital audio player and for storage.

At 910, the digital audio is stored in its new format, and at 912 converted to a format that is ubiquitously and easily disseminated, such as MP3. At 914, the audio is renamed, and can be tagged with various other metadata that is associated with the stored audio, and which can be searched for in a query. At 916, the stored audio content is moved to a client folder. At 918, the audio is embedded into a client RSS feed for distribution to a number of recipients. At 920, the audio is distributed in a podcast, i.e. packaged and transmitted in a downloadable digital audio format that can be locally stored on a digital audio player device or similar player, and played-back at the convenience of the recipient.

At 922-928, the audio content is consumed. The podcast containing the audio content can be consumed at a content site and/or media player (922), one or more private digital audio players (924), one or more web-based feed players (926), and/or an RSS player in any device, such as computer, PDA, mobile phone, or other device.

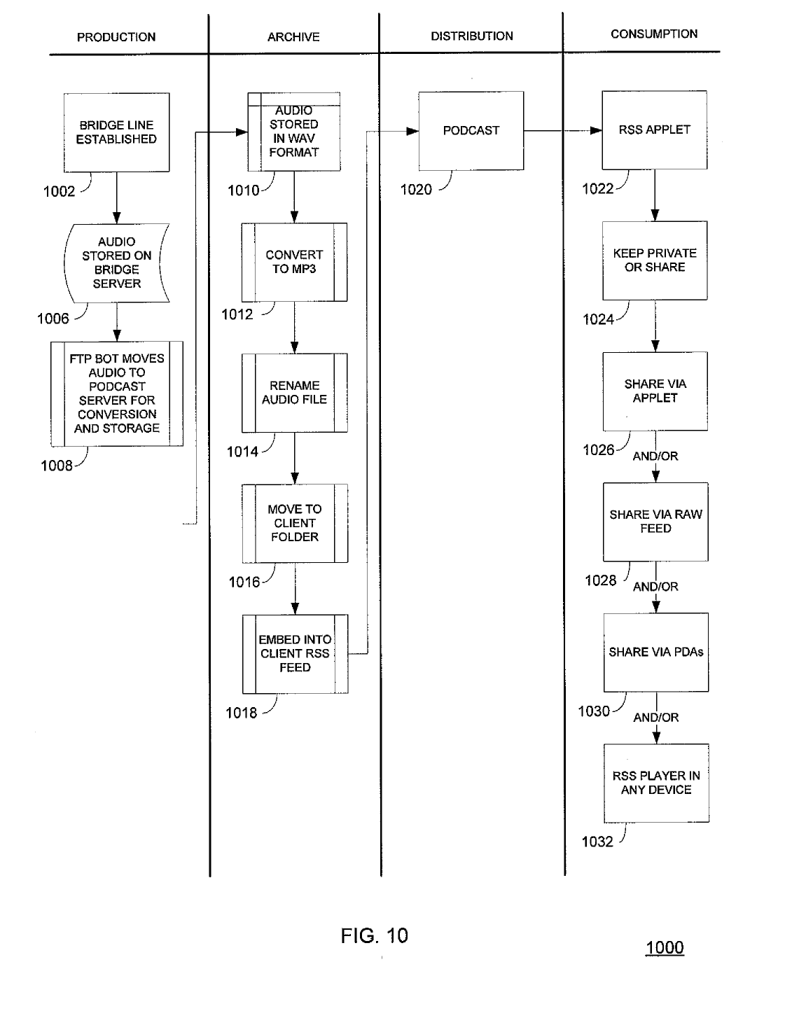

FIG. 10 shows a flowchart of a podcasting method 1000 for podcasting teleconference audio content, and which is suitable for a customer relationship management (CRM) system. At 1002 a teleconference bridge line is established. The bridge line is a dedicated telecommunications connection to which a number of participants and moderators can be connected. At 1004, the teleconference (i.e. “the call”) is recorded from the bridge line, and stored on a bridge server or other telecommunications server at 1006. At 1008, a file transfer automated program, or “bot,” transfers or pulls the stored audio from the bridge server to a podcast server, where it is converted into a new digital audio format conducive to a digital audio player and for storage.

At 1010, the digital audio is stored in its new format, and at 1012 converted to a format that is ubiquitously and easily disseminated, such as MP3. At 1014, the audio is renamed, and can be tagged with various other metadata that is associated with the stored audio, and which can be searched for in a query. At 1016, the stored audio content is moved to a client folder. At 1018, the audio is embedded into a client RSS feed for distribution to a number of recipients. At 1020, the audio is distributed in a podcast, i.e. packaged and transmitted in a downloadable digital audio format that can be locally stored on a digital audio player device or similar player, and played-back at the convenience of the recipient.

At 1022-1032, the audio content is consumed. The podcast containing the audio content can be consumed as an RSS applet (1022), kept private or designated to be shared at 1024, or shared via an applet at 1026. Alternatively, or in conjunction with the aforementioned consumption steps, the audio content can be shared via raw feed at 1028, shared via PDA at 1030, and/or distributed via an RSS player in any device, such as computer, PDA, mobile phone, or other device, at 1032.

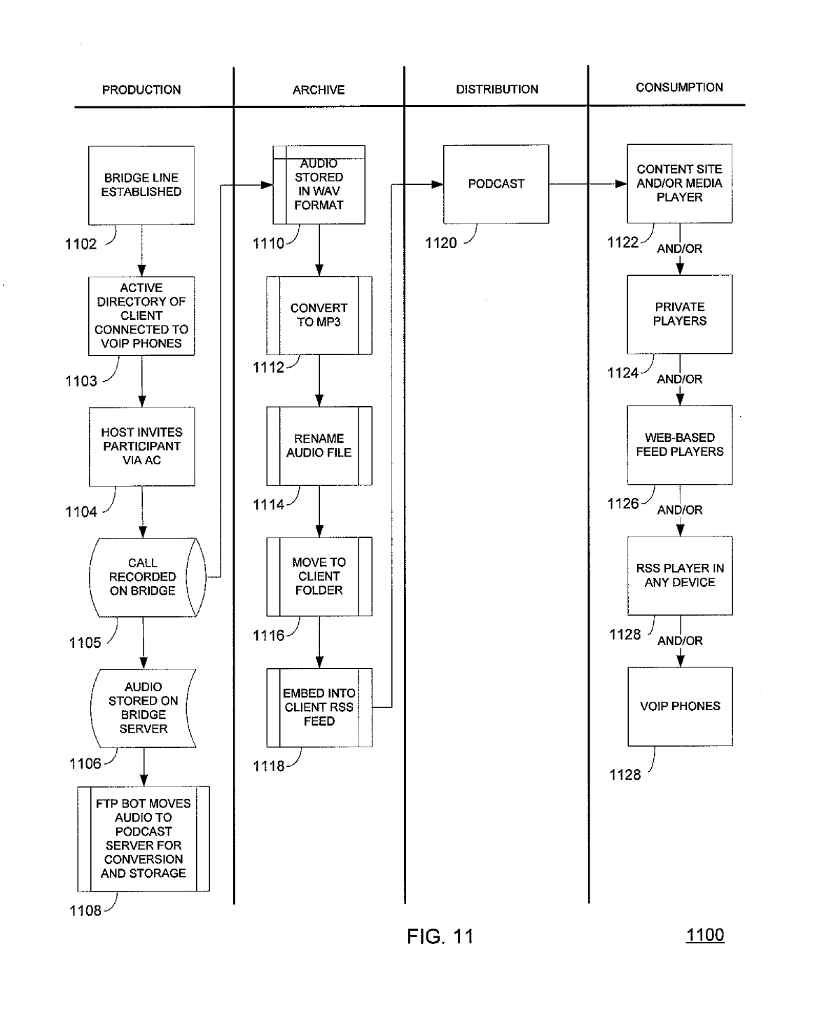

FIG. 11 shows a flowchart of yet another podcasting method 1100 for podcasting teleconference audio content which is suitable for a voice-over-IP (VOIP) implementation. At 1102 a teleconference bridge line is established. The bridge line is a dedicated telecommunications connection to which a number of participants and moderators can be connected. At 1103 an active directory is generated of clients connected to VOIP-enabled phones. At 1104, a host of the teleconference invites participants. At 1105, the teleconference (i.e. “the call”) is recorded from the bridge line, and stored on a bridge server or other telecommunications server at 1106. At 1108, a file transfer automated program, or “bot,” transfers or pulls the stored audio from the bridge server to a podcast server, where it is converted into a new digital audio format conducive to a digital audio player and for storage.

At 1110, the digital audio is stored in its new format, and at 1112 converted to a format that is ubiquitously and easily disseminated, such as MP3. At 1114, the audio is renamed, and can be tagged with various other metadata that is associated with the stored audio, and which can be searched for in a query. At 1116, the stored audio content is moved to a client folder. At 1118, the audio is embedded into a client RSS feed for distribution to a number of recipients. At 1120, the audio is distributed in a podcast, i.e. packaged and transmitted in a downloadable digital audio format that can be locally stored on a digital audio player device or similar player, and played-back at the convenience of the recipient.

At 1122-1128, the audio content is consumed. The podcast containing the audio content can be consumed at a content site and/or media player (1122), one or more private digital audio players (1124), one or more web-based feed players (1126), an RSS player in any device, such as computer, PDA, mobile phone, or other device (1128), and/or by any of a number of VOIP-enabled phones (1128).

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A method comprising:
establishing a bridge line for a teleconference among a plurality of participants and at least one moderator, each of the participants and the at least one moderator using a telephone device to communicate with the bridge line;
recording the teleconference as digital storage format information;
converting the digital storage format information associated with the teleconference into digital playback format information; and
distributing the digital playback format information as a podcast to a plurality of recipients.

2. A method in accordance with claim 1, wherein the digital playback format includes an MP3 format.

3. A method in accordance with claim 1, wherein the digital storage format includes a .WAV format.

4. A method in accordance with claim 1, wherein the bridge line includes a telecommunications network connection.

5. A method in accordance with claim 4, wherein the telecommunications network connection includes a VOIP connection.

6. A method in accordance with claim 4, wherein the telecommunications network connection includes at least one wireless connection.

7. A computer-implemented method for distributing teleconference audio content, the method comprising:
storing audio content from a bridge line associated with a teleconference;
converting the stored audio content to a podcasting format associated with a podcasting website; and
distributing the stored audio content in the podcasting format to one or more recipients having access to the podcasting website.

8. A method in accordance with claim 7, wherein the podcasting format includes an MP3 format.

9. A method in accordance with claim 7, wherein the stored audio content is formatted according to a .WAV format.

10. A method in accordance with claim 7, wherein the podcasting website is generated in XML.

11. A method in accordance with claim 7, wherein the bridge line includes at least one VOIP connection.

12. A method in accordance with claim 7, wherein the bridge line includes at least one wireless connection.

13. A system for distributing teleconference audio content, the system comprising:
a setup page for receiving user information associated with one or more stored audio files;
a server system for storing the received user information with the one or more stored audio files, and for accessing the stored audio files upon receipt of a query associated with the user information; and
a podcasting server coupled with the server system for distributing the accessed audio files to one or more recipients associated with the query.

14. A system in accordance with claim 13, wherein the setup page is downloadable into a browser interface of a client computer.

15. A system in accordance with claim 13, wherein the stored audio files are each stored as a .WAV formatted file.

16. A system in accordance with claim 13, wherein the user information includes a title.

17. A system in accordance with claim 13, wherein the user information includes a content description.

18. A system in accordance with claim 13, further comprising a player system adapted to play the distributed audio content.
